(19) United States
(12) Patent Application Publication
(10) Pub. No.: US 2023/0193086 A1
(43) Pub. Date: Jun. 22, 2023

(54) INDUSTRIAL FLOOR MARKING TAPE

(71) Applicant: PATCH RUBBER COMPANY, Weldon, NC (US)

(72) Inventors: Marlo CARTER, Roanoke Rapids, NC (US); Timothy DONLEY, Rocky Mount, NC (US); Christopher J. VIDOLI, Wake Forest, NC (US)

(21) Appl. No.: 18/085,155

(22) Filed: Dec. 20, 2022

Related U.S. Application Data
(60) Provisional application No. 63/292,213, filed on Dec. 21, 2021.

(51) Int. Cl. C09J 7/38; C09J 7/24; C09D 5/33

(52) U.S. Cl. CPC C09J 7/38; C09J 7/243; C09D 5/004

(57) ABSTRACT

The present disclosure relates to an industrial marking tape. In one or more embodiments, the industrial tape can comprise a plastic substrate layer comprising a polycarbonate material, a polyethylene material, or a combination thereof. Additionally, the industrial tape can comprise a paint layer positioned adjacent to the plastic substrate layer. Further, the industrial tape can comprise an adhesive layer positioned adjacent to the plastic substrate layer or the paint layer.

### CROSS-REFERENCE TO RELATED APPLICATION

This application claims priority benefit of U.S. Provisional Patent Application Ser. No. 63/292,213 filed Dec. 21, 2021, entitled “INDUSTRIAL FLOOR MARKING TAPE,” the complete disclosure of which is herein incorporated by reference in its entirety.

### BACKGROUND

Floor marking tapes are adhesive tapes used to mark hazards, divide spaces, create aisles, or provide directions. They are commonly used in industrial and manufacturing facilities for floor marking. Floor marking tapes are also useful for helping workers put materials and equipment back in the right place, making it a key Lean Manufacturing implementation tool. Floor markings are used in industrial workplaces as a way of complying with requirements by the Occupational Safety and Health Administration (OSHA) which requires that aisles and passageways be marked in areas where material handling equipment, such as forklifts are used.

Tapes are replacement for paints for floor marking. Tapes are much faster and easier to install and replace, which dramatically reduces down times related to painting aisles and rails. Typical markings tapes include a colored vinyl backing layer and adhesive layer. However, these tapes periodically fail in the industrial setting, where the vinyl layer can separate or discolor. Marking tapes that fail to be removed and/or replaced. The present disclosure provides certain improvements to industrial floor marking tapes, including increased lifetime.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In accordance with one aspect of the present disclosure, an industrial tape is provided. The industrial tape can comprise a plastic substrate layer comprising a polycarbonate material, a polyethylene material, or a combination thereof. The industrial tape can also comprise a paint layer positioned adjacent to the plastic substrate layer. Additionally, the industrial tape can comprise an adhesive layer positioned adjacent to the plastic substrate layer or the paint layer.

In accordance with another aspect of the present disclosure, a method for producing an industrial tape is provided. The method can comprise providing a plastic substrate layer, wherein the plastic substrate layer comprises a polycarbonate material, a polyethylene material, or a combination thereof. The method can also comprise applying a paint layer to a first side of the plastic substrate layer. Additionally, the method can comprise applying an adhesive layer to second side of the plastic substrate layer or to the paint layer.

In accordance with another aspect of the present disclosure, another industrial tape is provided. The industrial tape can comprise a paint layer positioned between a plastic substrate layer and an adhesive layer. The plastic substrate layer can cover the paint layer and can thereby be configured to protect the paint layer from mechanical forces. Additionally, the adhesive layer is configured to adhere the paint layer and the plastic substrate to a target surface

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a cross-section of an exemplary industrial marking tape in accordance with one or more embodiments described herein.

FIG. 2 is a cross-section of another exemplary industrial marking tape in accordance with one or more embodiments described herein.

### DETAILED DESCRIPTION

The present disclosure is related to that industrial tapes used for floor markings. The industrial tapes disclosed herein last longer than other products and options currently on the market. The industrial tapes are also designed to withstand certain industrial cleaners, therefore making the tape “cleanable.”

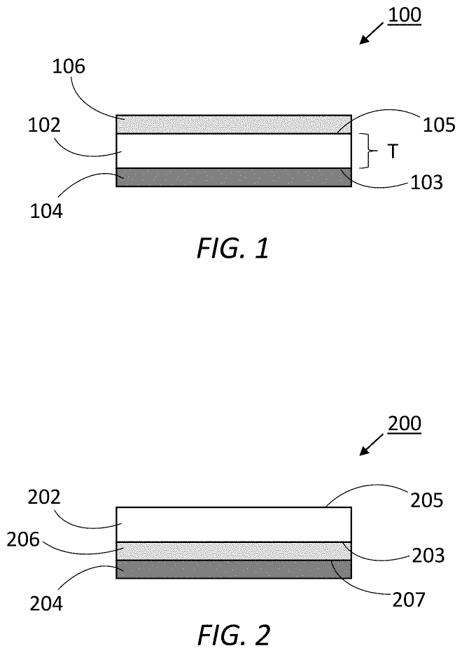

FIG. 1 is a cross-section of a first example industrial tape 100 embodiment in accordance with one or more embodiments described herein. The industrial tape 100 includes a plastic substrate layer 102, an adhesive layer 104, and a paint layer 106. As illustrated in the exemplary embodiment, the plastic substrate layer 102 has a top surface 105 and a bottom surface 103. The adhesive layer 104 is adjacent to the bottom surface and facilitates adhesion of the tape 100 to a surface/floor. The paint layer 104 is adjacent to the top surface plastic substrate layer 102 and provides the color and desired surface properties of the industrial tape 100.

The plastic substrate layer 102 is generally a durable material having sufficient impact resistance and chemical resistance. In some embodiments, the plastic substrate layer 102 may include a hard coating layer to increase the chemical resistance and durability properties of the plastic material. In some embodiments, the plastic substrate later 102 is formed of a polycarbonate (“PC”) material. In other embodiments, the plastic substrate layer 102 is formed of a polyethylene (“PE”) material. In yet other embodiments, the plastic substrate layer 102 is formed of a polyethylene terephthalate (“PET”) material. In still yet other embodiments, the plastic substrate layer 102 is formed of a polyethylene terephthalate glycol (“PETG”) material. In some embodiments, the plastic substrate layer 102 can be composed of any combination of: PC material, PE, PET, and/or PETG. It is to be appreciated that this list of plastics is non-limiting and that other plastic materials having similar properties may be substituted herein without departing from the scope of this disclosure. In some embodiments, the plastic material for the plastic substrate layer 102 is substantially transparent. That is, a color paint applied on one side of the plastic substrate layer 102 is viewable from the other side of the plastic substrate layer 102. In yet other embodiments, the plastic substrate layer 102 provides sufficient rigidity such that is it easier to lay long pieces of tape to a target surface and have a substantially straight line. That is, flimsily tapes, such as masking tape for paint application, are difficult to lay is long straight lines.

The plastic substrate layer 102 has a thickness T that ranges from about 0.003 inches (3 millimeters) to about 0.030 inches (30 millimeters). Common commercially available thickness of plastics include but are not limited to 0.003, 0.004, 0.005, 0.006, 0.007, 0.008, 0.012, 0.014, 0.015, 0.02, and 0.030 inches. It is to be appreciated that the thickness T of the plastic substrate layer 102 is not limited to commercially available sheet thickness but may be any thickness in the range thereof. As briefly mentioned above, the plastic substrate layer 102 can include a hard coat layer on one or both sides of the plastic layer 102 (e.g., positioned on the top surface 105 and/or the bottom surface 103). Generally, the thickness of the hard coat layer on the plastic substrate layer 102 is measured in microns and therefore, its effect on the overall thickness of the plastic substrate layer 102 is negligible. Hard coats may be chosen for a variety of factors including promoting adhesion for the adhesive and/or paint layer, chemical resistance as well as durability properties.

As illustrated in FIG. 1, the adhesive layer 104 is applied to the bottom surface 103 of the plastic substrate layer 102. Thereby, the tape 100 can comprise the plastic substrate layer 102 positioned between the paint layer 106 and the adhesive layer 104 along a thickness direction of the tape 100, as shown in FIG. 1. The adhesive layer's 104 location on the bottom surface 103 can serve to facilitate adhesion of the tape 100 to a target surface. In preferred embodiments, that adhesive layer 104 is a pressure sensitive adhesive, a generally non-reactive adhesive which forms an adhesive bond when pressure is applied to the tape 100. In other embodiments, the adhesive layer 104 may be a water/solvent activated adhesive. In yet still other embodiments, the adhesive layer 104 can be a heat activated adhesive.

The thickness of the adhesive layer 104 can range from, for example, about 0.002 inches (2 millimeters) to about 0.025 inches (25 millimeters). However, the thickness of the pressure sensitive adhesive layer 104 is not limiting.

As also illustrated in FIG. 1, the paint layer 106 can be applied to the top surface 105 of the plastic substrate layer 102. In this way, the paint layer 106 can be the topmost layer of the tape 100. Additionally, the paint layer 106 can be colored or patterned as desired. In some embodiments, the paint layer 106 comprises a urethane-based paint. In other embodiments, the paint layer 106 comprises a polyurethane-based paint. As a top layer of the tape 100, the paint layer 106 can exhibit sufficient adhesion to the plastic substrate layer 102. In some further embodiments, the paint layer 106 is also resistant to typical cleaning chemicals; thereby enabling the tape 100 to be cleaned without damaging the structure or color properties of the tape 100.

In some embodiments, the paint layer 106 further includes at least one surface enhancing material. For example, the paint layer 106 may include particles or “grit” for enhancing the texture of the tape 100, providing slip-resistant properties. In yet other embodiments, the paint layer 106 further includes at least one reflective material providing reflective properties to the tape 100. In yet still other embodiments, the paint layer 106 may include a phosphorescent material providing a “glow-in-the-dark” property to the industrial tape 100. In various embodiments, the surface enhancing material can be integrated within the paint layer 106 and/or positioned at a top surface of the paint layer 106 that is opposite the top surface 105 of the plastic substrate layer 102.

FIG. 2 is a cross-section of a second example industrial tap 200 embodiment in accordance with the one or more embodiments described herein. The industrial tape 200 includes a plastic substrate layer 202, an adhesive layer 204, and a paint layer 206. Each layer 202, 204, and 206 are similar to the layers 102, 104, and 106 respectively and best understood with respect thereto.

As illustrated in the exemplary embodiment, the plastic substrate layer 202 has a bottom surface 203 and a top surface 205. The plastic substrate layer 202 can be the topmost layer of the tape 200 while the adhesive layer 204 can be the bottommost layer of the tape 200. As show in FIG. 2, the paint layer 206 is sandwiched between the bottom surface 203 of plastic substrate layer 202 and the adhesive layer 204. In other words, the paint layer 206 can be positioned between the plastic substrate layer 202 and the adhesive layer 204 along a thickness direction of the tape 200. In this way, the plastic substrate layer 202 provides a protective covering over the intermediate paint layer 206, where the paint layer 206 is less likely to separate from the tape 200 or otherwise be damaged due to mechanical forces (wear, scratching, scuffing, and the like). For example, the plastic substrate layer 202 can cover the paint layer 206 (e.g., as shown in FIG. 2) and thereby be configured to protect the paint layer 206 from the mechanical forces. The adhesive layer 206 is applied to the bottom surface 207 of the paint layer 206. For example, the adhesive layer's 204 position below the paint layer 206 can thereby configure the adhesive layer 204 to adhere the paint layer 206 and the plastic substrate layer 202 to a target surface.

In some embodiments, the top surface 205 of the plastic substrate layer 202 includes a hard coat to provide impact, scratch, and/or chemical resistance to the tape 200. In other embodiments, the top surface 205 of the plastic substrate layer 202 further includes at least one surface enhancing material. For example, the top surface 205 of the plastic layer 202 may include particles or “grit” for enhancing the texture of the tape 200, providing slip-resistant properties. In yet other embodiments, the top surface 205 of the plastic substrate layer 202 further includes at least one reflective material providing reflective properties to the tape 200. In yet still other embodiments, the top surface 205 of the plastic substrate 202 may include a phosphorescent material providing a “glow-in-the-dark” property to the industrial tape. The reflective materials and/or the phosphorescent material may be incorporated in the intermediate paint layer 206.

The industrial tapes 100, 200 described herein are preferably configured as a roll of tape of a certain width often wound around a core, allowing for a length to be pulled from the roll and applied to a target surface. In some embodiments, the industrial tapes 100, 200 may be perforated having predetermined lengths of tape material.

In accordance with another aspect of the present disclosure, a method for manufacturing an industrial marking tape is disclosed. The method includes: providing a plastic substrate layer 102, 202; applying a paint layer 106, 206 to one side of the plastic substrate layer 102, 202; and applying an adhesive layer 104, 204 to either the plastic substrate layer 102, 104 or the paint layer 106, 206.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below.

It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. An industrial tape, comprising:
a plastic substrate layer comprising a polycarbonate material, a polyethylene material, or a combination thereof;
a paint layer positioned adjacent to the plastic substrate layer; and
an adhesive layer positioned adjacent to the plastic substrate layer or the paint layer.

2. The industrial tape according to claim 1, wherein the adhesive layer is adjacent to a bottom surface of the plastic substrate layer, and wherein the paint layer is adjacent to a top surface of the plastic substrate layer.

3. The industrial tape according to claim 1, wherein the plastic substrate layer is positioned between the paint layer and the adhesive layer along a thickness direction of the industrial tape.

4. The industrial tape according to claim 1, wherein the paint layer is adjacent to a bottom surface of the plastic substrate layer, and wherein the adhesive layer is adjacent to the paint layer.

5. The industrial tape according to claim 1, wherein the paint layer is positioned between the plastic substrate layer and the adhesive layer along a thickness direction of the industrial tape.

6. The industrial tape according to claim 1, wherein the polyethylene material is polyethylene, polyethylene terephthalate, polyethylene terephthalate glycol, or a combination thereof.

7. The industrial tape according to claim 1, wherein the plastic layer further comprises a hard coat.

8. The industrial tape according to claim 1, wherein the adhesive layer is a pressure sensitive adhesive.

9. The industrial tape according to claim 1, wherein the paint layer is a urethane-based paint.

10. The industrial tape according to claim 1, wherein the plastic substrate layer further comprises a friction enhancing material, a reflective material, a phosphorescent material, or a combination thereof.

11. A method for producing an industrial tape, the method comprising:
providing a plastic substrate layer, wherein the plastic substrate layer comprises a polycarbonate material, a polyethylene material, or a combination thereof;
applying a paint layer to a first side of the plastic substrate layer; and
applying an adhesive layer to second side of the plastic substrate layer or to the paint layer.

12. The method of claim 11, wherein the adhesive layer is applied to the second side of the plastic substrate layer such that the plastic substrate layer is positioned between the paint layer and the adhesive layer.

13. The method of claim 11, wherein the adhesive layer is applied to the paint layer.

14. The method of claim 13, wherein the applying the adhesive layer positions the paint layer between the plastic substrate layer and the adhesive layer.

15. The method of claim 11, wherein the polyethylene material is polyethylene, polyethylene terephthalate, polyethylene terephthalate glycol, or a combination thereof.

16. The method of claim 11, wherein the adhesive layer is a pressure sensitive adhesive.

17. An industrial tape, comprising:
a paint layer positioned between a plastic substrate layer and an adhesive layer, wherein the plastic substrate layer covers the paint layer and is configured to protect the paint layer from mechanical forces, and wherein the adhesive layer is configured to adhere the paint layer and the plastic substrate to a target surface.

18. The industrial tape of claim 17, wherein the plastic substrate layer comprises a polycarbonate material, a polyethylene material, or a combination thereof.

19. The industrial tape of claim 18, wherein the polyethylene material is polyethylene, polyethylene terephthalate, polyethylene terephthalate glycol, or a combination thereof.

20. The industrial tape of claim 17, wherein the paint layer is a urethane-based paint.
